(19) United States
(12) Patent Application Publication
(10) Pub. No.: US 2004/0025190 A1
(43) Pub. Date: Feb. 5, 2004

(54) System and method for video-on -demand based gaming

(75) Inventors: John McCalla, Montreal (CA); Yves D'Aoust, St -Lambert (CA)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(73) Assignee: Bluestreak Technology Inc., Irving, TX

(21) Appl. No.: 10/631,084

(22) Filed: Jul. 31, 2003

Related U.S. Application Data
(60) Provisional application No. 60/400,315, filed on Jul. 31, 2002.
(60) Provisional application No. 60/400,316, filed on Jul. 31, 2002.
(60) Provisional application No. 60/400,317, filed on Jul. 31, 2002.

(51) Int. Cl. A63F 9/24; A63F 13/00; H04N 7/173

(52) U.S. Cl. 725/133; 463/1; 463/40

(57) ABSTRACT

In accordance with an embodiment, a system and method for playing a game using video content as the game environment is disclosed. The video content may be provided from a video-on-demand system or using broadcast video signals. Depending on the object of the game, the player may try to hit, shoot or avoid specific objects in the video content environment. Those objects are identified at the time of authoring the game. During the game, a game application knows about the objects and can evaluate the performance of the player. Use of on-demand or live broadcast video source as the context environment for a game is disclosed. The game application is synchronized with the video content.

### RELATED APPLICATIONS

This patent application claims the benefit of Provisional Patent Application, Serial No. 60/400,315, entitled TV Ticker, filed on Jul. 31, 2002; Provisional Patent Application, Serial No. 60/400,316, entitled Internet Browsing for Television Interaction Devices, filed on Jul. 31, 2002; and Provisional Patent Application, Serial No. 60/400,317, entitled Video-On-Demand Based Game Playing, filed on Jul. 31, 2002; the disclosures of all of which are incorporated herein by reference.

### TECHNICAL FIELD OF THE INVENTION

The present invention relates generally to the field of interactive television, and more particularly to a system and method for video-on-demand based gaming.

### BACKGROUND OF THE INVENTION

There are several problems in presenting multimedia content, including for example, web content and games, on or using computer devices having limited memory, processing capability, output capabilities, display capabilities, and/or communication capability, such as interactive television systems. The first one is the size of the computer programs used in connection with presenting the multimedia content. The typical interactive set-top box for cable television reception only has around 8 MB of memory. A satellite television receiver has even less memory typically between 2 and 4 MB. A typical interactive or digital television “set-top box,” as cable and satellite television receivers are often called, is quite limited in capabilities compared to what exists on a regular computer.

A second problem is related to the screen resolution. For example, a television screen has substantially fewer pixels than the typical computer screen. In NTSC (National Television Standards Committee) mode, the effective resolution is 646 by 486. For PAL (Phase Alternate Lines), the resolution is 768 by 576.

A third problem is transmission of multimedia content and applications, for example on an interactive or on-demand basis, often imposes significant bandwidth demands on networks to which these devices may be connected. Often, these networks are not capable of, or were not intended for, transmitting large multimedia files and applications.

### SUMMARY OF THE INVENTION

The invention has as an objective running of multimedia content and applications, particularly, but not limited to, on an interactive basis, on devices with limited memory processing, and/or limited memory or display capabilities, such as interactive television set-top boxes, hand-held personal digital assistants, cellular telephones and similar special purpose devices having embedded software instruction processing capabilities.

In accordance with an embodiment, a system and method for combining video content and a game application comprising of interactive elements to enable a user to play a game synchronized with the video content is disclosed.

In accordance with another embodiment, a system and method for playing a game using video content as the game environment is disclosed. The video content may be provided from a video-on-demand (VOD) system or using broadcast video signals. Depending on the object of the game, the player may try to hit, shoot or avoid specific objects in the video content environment. Those objects are identified at the time of authoring the game. During the game, a game application knows about the objects and can evaluate the performance of the player. Use of on-demand or live broadcast video source as the context environment for a game is disclosed. The game application is synchronized with the video content.

Other aspects and features of the invention will become apparent to those ordinarily skilled in the art upon review of the following description of specific embodiments of the invention in conjunction with the accompanying figures.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of an example of an interactive or digital television system in which the present invention may be employed to particular advantage;

FIG. 2 is a high level diagram of a system for internet browsing;

FIG. 3 is a high level diagram of a system for retrieving content by an interactive television device;

FIG. 4A is a logical block diagram for a system for content browsing on the client side;

FIG. 4B illustrates an exemplary user-interface for content browsing;

FIG. 5 is a flowchart of an exemplary method for providing content to an interactive television device;

FIG. 6 is a flowchart of an exemplary method for converting a web page from an existing format to an advanced movie format;

FIG. 7A is a logical diagram of a system for gaming;

FIG. 7B is a high-level diagram of a system for video-on-demand gaming;

FIG. 8 is a flowchart of an exemplary method for authoring video content to associate synchronizing trigger information for gaming; and

FIG. 9 is a flowchart of an exemplary method for synchronizing video content and the game application, with reference to an interactive television device.

### DETAILED DESCRIPTION OF THE DRAWINGS

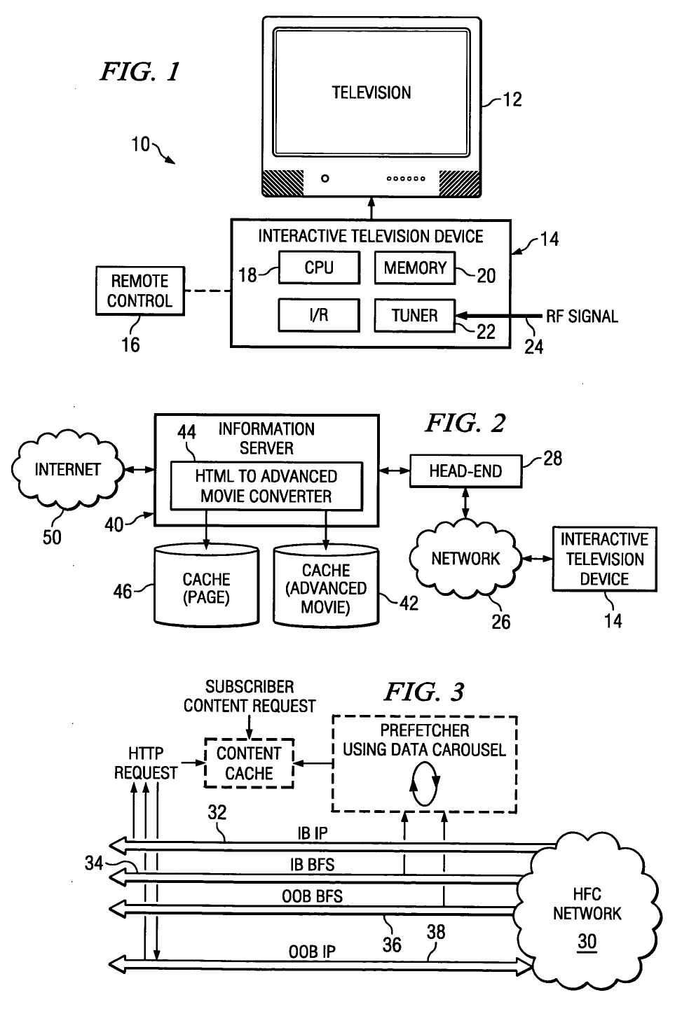

The preferred embodiment of the present invention and its advantages are best understood by referring to FIGS. 1 through 9 of the drawings.

FIG. 1 is a block diagram of an example of an interactive or digital television system 10 in which the present invention may be employed to particular advantage. The terms “interactive television” and “digital television” are used interchangeably herein. Interactive television refers to the television experience where a user can interact with content presented on his/her television screen 12. To enable this interaction, it is desirable that the viewer has an interactive television device 14, like a set-top box, and a remote control 16. Interactive television device 14 is not limited to a set-top box. If desired, television set 12 could integrate the interactive television device, or the interactive television device could be incorporated into another device connected to the television set. Interactive television device 14 is an example of a device having limited processing, memory and display capabilities.

Interactive television device 14 accepts user input and presents the content to the viewer. Depending on the content, various interaction methods are available. Remote control 16 is the most common tool for interaction with the interactive television device 14. If desired, a wireless keyboard may be used. Most commonly, navigation and selection keys (e.g. arrows, page up/down) are used to select the content of interest and activate it. The user interface of interactive television applications is preferably operable by remote control 16.

In general, a typical interactive television device 14 can be characterized as a computer, which executes software instructions, with circuitry for processing data streams, for example data streams carried by modulated RF (Radio Frequency) signals 24. An interactive television device has, as compared to personal and other types of computers, limited processing and data storage capabilities. Interactive television device 14 comprises a central processing unit (CPU) 18, a memory 20, for example random access memory (RAM) and read only memory (ROM), and/or a television tuner 22.

Interactive television device 14 communicates with a network designed primarily for transmission of television services. There are presently three types of widely used television transmission networks: DSL (Digital Subscriber Line), cable and satellite. Content (television programs, pay per view programming, interactive applications, etc.) is encoded into digitals signals, for example RF signals, transmitted over the network. Interactive television device 14 receives digital signal 24 and processes it. When a viewer is watching conventional television (as opposed to interactive television), digital signal 24 passes through interactive television device 14 without any processing. A digital signal and/or video content may include triggers that would initiate processing from interactive television device 14. Using remote control 16, the viewer has the same interactions (e.g., channel up/down, entering a channel number, etc.) with interactive television device 14 that he/she would with his/her regular television set 12.

Interactive television device 14 may store one or more resident applications. A resident application is a software program (an application) loaded in non-volatile or volatile memory to do a particular task, e.g. present a services menu. The resident application is present in memory to respond to user actions.

When a resident application is running, it may need content or other application to be also loaded into memory. The resident application looks at information carried by digital signal 24 to check if the information that it is looking for is available there. A digital signal may comprise several parts. For example, one part may be contained in the analog television channels while another may be in the digital channels.

A digital signal may be used to transmit data information, i.e. information encoded as binary digits or bits. For example, depending on the format of the digital signal, this information may be interpreted as comprising a television channel, an audio program or a data stream. Within the data stream information on directories and files may be located. Such data stream could be like any regular file system on a computer system, except that it is broadcasted. Hence, it is referred to as a broadcast file system (BFS).

When a resident application desires content or an application, the interactive television device may look for it on the BFS in the signal. If the content or application is there, it is loaded in memory. Otherwise, interactive television device 14 may request the interactive television network, to which it is connected, that the information be added to the broadcast file system. FIG. 2 is a high level diagram of a system for Internet browsing. The broadcasting point of network 26 is a head-end 28. Network 26 may comprise a packet network. Information servers 40 are located at head-end 28 and the addition of information to the file system is handled by head-end 28. So this combination makes information server 40 and interactive television device 14 equivalent to a client/server configuration.

The resident application may as an alternative for retrieving information communicate over an IP (Internet Protocol) network 30 that runs over, for example, a Hybrid Fiber Coaxial (HFC) network, such as the one illustrated in FIG. 3. FIG. 3 is a high level diagram of a system for retrieving content by interactive television device 14 (FIG. 1). In the illustrated example of FIG. 3, in-band (IB) channels 32 and 34 and out-of-band (OOB) channels 36 and 38 are used to communicate. IB channels 32 and 34 and OOB channels 36 and 38 are data pipes between the head-end and interactive television device 14.

When an application is activated by the viewer, the application is loaded in memory 20 where it executes. If desired, content used by the application may be loaded in memory 20 or processed directly from the broadcast file system. Various activation methods are available, e.g. a menu item, a hot key on remote control 16, etc.

A more efficient way to deliver Internet content to television viewers is provided. An information server 40 (FIG. 2), such as a web server, outputs the content in one or more advanced movie files, for example MACROMEDIA FLASH movies, which are sent to the resident application on interactive television device 14 of the television viewer. Those advanced movie files are the equivalent of the web pages and are of the same quality as the web pages.

A technical advantage of this approach is reduction in the amount of information sent across operator network 26. The elements that compose a web page are converted into an advanced movie file (and a small number of associated information) which is sent across operator network 26. The advanced movie format is a presentation format capable of supporting, but not limited to, one or more of the following: text, graphic drawing, images, animation, sounds and program code. It is desirable that the format work in multiple resolutions. An example of such a format is the MACROMEDIA FLASH format or a subset thereof.

Another technical advantage of this approach is the reduction in the processing power desirable to display the content. Since the rendering of the Internet content is done in information server 40, less processing is performed by interactive television device 14.

Another technical advantage of this approach is that richer content may be provided to the user. By using the advanced movie format, it is not only possible to take content in HyperText Markup Language (HTML) format and provide it to interactive television device 14 but also, make a new type of content available. This is something that the other browsers are not able to do without a substantial increase in their memory footprint.

Another technical advantage of this approach is that resources may be better managed. The size of some web pages is large. If a viewer was to ask for the page to be downloaded to interactive television device 14, it may not fit in memory 20. In accordance with an embodiment of the present invention, the content is cached on the server side, for example, in an advanced movie file cache 42 associated with information server 40, and only a number of pages are delivered to interactive television device 14 such that physical memory 20 is not overloaded. As the viewer navigates the page, information server 40 provides the desirable sections of the page for display. For example, the page may comprise of a plurality of URLs. As the user navigates the page and selects a URL, information server 40 provides the associated content.

Another technical advantage of this approach is that multiple resolutions may be supported. One of the desirable qualities of an advanced movie format, such as MACROMEDIA FLASH, is its ability to work in multiple resolutions. This means the content can easily be adapted to meet the needs of display device 12.

Another technical advantage of this approach is the availability of MPEG decoder. Because the information is transmitted using IP network 26, the MPEG and analog video decoder is available to do something else, for example, decode the television signal.

Another technical advantage of this approach is the retention of the intelligence of the HTML pages. Scripting used with the HTML pages are converted into the language of the advanced movie format.

This approach transfers a significant amount of the processing burden to information server 40. A server typically has more power than an interactive television device and the server evolution path (processor speed, memory, bus bandwidth, etc) is much faster. If information server 40 cannot sustain the viewers' demands, additional servers may be brought on-line or more powerful servers may be deployed. It is much easier for an operator to change a server than the viewer's devices.

An exemplary embodiment of the present invention provides a solution to the video streaming problem. Many pages incorporate an area to display video. In order to do this, a network infrastructure that delivers streaming content to interactive television device 14 is desirable.

Preferably, most of the components are located at the operator's headend 28. Converter 44 is preferably part of or associated with information server 40, like Microsoft Internet Information Services (IIS) or an Apache server. Converter 44 converts HTML pages into their advanced movie format equivalent. Converter 44 comprises a modified web browser, which has a new rendering function. This function converts the content from one format to the other.

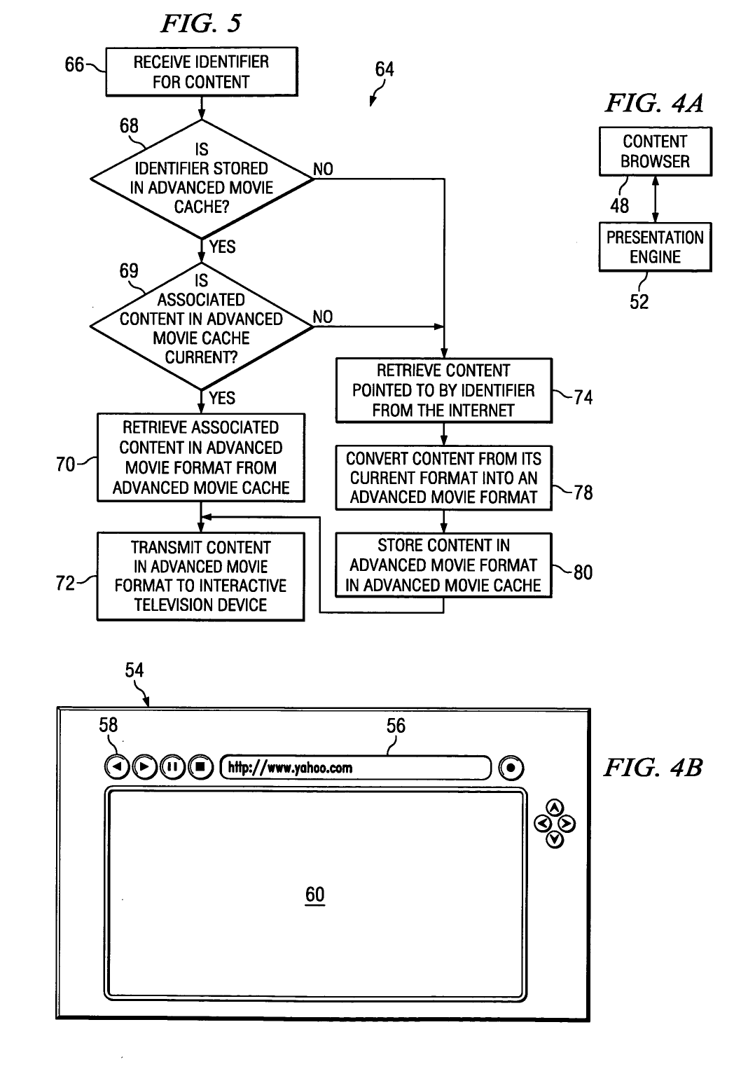

To optimize the Internet browsing experience, preferably two caches 42 and 46, are used. Page cache 46 stores pages that were loaded. Advanced movie file cache 42 is used for the converted pages, i.e. the advanced movie files. Those movies are delivered to the viewer's interactive television device 14. Interactive television device 14 comprises a resident application 52 and a content browser application 48 (FIG. 4A). FIG. 4A is a logical block diagram for a system for content browsing on the interactive television device. FIG. 4B illustrates an exemplary user-interface for content browsing.

When a viewer starts content browser application 48 on interactive television device 14, a request for a page is made. The first request will typically be for the default page, also known as the home page. The process to get the page from information server 40 to interactive television device 14 is the same for the default page or a typed URL (Universal Resource Locator). The request travels using the back channel of interactive television device 14. Depending on the type of networks (DSL, satellite or cable), the request will be part of the cable signal or a modem will be used to send the request. When the request reaches the network distribution point, information server 40 takes care of the request. It should be noted that frequently used pages, like the operator portal, may reside on the BFS. This simplifies the request process because the pages can directly be used without having to go to head-end 28.

If the requested page is available in advanced movie cache 42 of information server 40, the content of advanced movie cache 42 is used and the content is sent back to interactive television device 14. If advanced movie cache 42 is not able to handle the request, the request may be passed to Internet 50. The program handling the request, i.e. converter 44, comprises a modified web browser.

When a content browser makes a request for a web page on the Internet, it receives the content of the requested page. Typically the formatting of the web page is specified or defined in HTML. The language defines the position of each element (text, image, graphics, video, animation, etc.), the size of the font, the color of the text, the paragraph structure, etc. Some pages may be broken into sub-pages, i.e. frames. A frame can be used for several purposes. It is most often used to structure the page in more manageable areas. For example, a navigation bar that does not change from page to page will typically be in a frame. More complex pages have scripts to perform certain actions. In recent years, XML (extensible Mark-up Language), and XSL (extensible Stylesheet Language), are being increasingly used on the Internet to describe and format content. The invention is not limited to HTML, XML or XSL. Any language used to format Internet content may be converted to the advanced movie format.

In existing systems, when a browser receives the information from the Internet, it interprets this information and prepares the page to be displayed. This process is called the rendering of a page.

In an embodiment of the present invention, instead of rendering the page to be displayed in a browser, the rendering process is replaced by a conversion process executing preferably on information server 40. A drawing space for drawing the web page is initialized. The dimensions of the space are determined by the web page or the target platform, for example television display device 12. The web page normally indicates the dimensions to use for the page. If not, the platform's resolution is used. The HTML instructions are converted so that they may be drawn in the drawing space.

For each rendering action, the equivalent element in the advanced movie format is determined as shown in exemplary Table A below. For example, a list item in HTML is converted into drawing instructions.

TABLE A

| | | |
|---|---|---|
| HTML | Advanced Format | Example |
| <LI> text </LI> | draw_circle x, y, radius | • text |
| | draw_text x + a, y, “text” | |

Depending on the advanced movie format desired, the mapping may be different. For example, the format could have a single primitive that maps directly with the HTML list item element. It is desirable to map all the HTML primitives into elements of the advanced movie format. When a direct mapping is not possible, an approximation may be used or the item may be rejected.

During the conversion process, the various elements are stored in advanced movie cache 42 and page cache 46 so they will not have to be downloaded from the Internet at the next viewer request. The movie is transmitted using the operator network to interactive television device 14.

Interactive television device 14, also known as the client, comprises content browser 48. Content browser 48 comprises a user interface 54 as illustrated in FIG. 4B running on top of a presentation engine 52 capable of displaying advanced movie-based content. In interactive television device 14, content browser 48, which is built on top of presentation engine 52 (FIG. 4A), displays the received advanced movie file in the content browser user interface 54.

Content browser interface 54 has similar functions as the web browser, like INTERNET EXPLORER or NAVIGATOR. It comprises a text field 56 to type in the URL of the site to visit. It comprises a “Back” button 58 to return to a previously visited site and a “home” page button to return to the viewer's default web page. There is a display area 60 for the advanced movie content. The content browser can be built to match the user interface that the operator wishes to have.

The content browser comprises an application running on top of presentation engine 52. There is very little logic in the content browser since most of the work is done at the server side. The content presented in display area 60 is another advanced movie file. Presentation engine 52 executes instructions found in the advanced movie file it receives and displays content in display area 60.

The quality of the HTML presented to the viewers is not compromised. The quality of the content provided using teachings of an embodiment of the present invention is the same as that obtained from a regular browser on a regular computer. Furthermore, the application does not monopolize the MPEG and analog video decoder of interactive television device 14.

The conversion of HTML frames into individual advanced movie files provides another advantage. The disadvantage of integrating content from all the frames into a single advanced movie file is that the operator's network would be loaded with content that may never be requested or viewed by the user. By breaking the content of the frames into individual advanced movie files, a more efficient use of the network is made. The advanced movie files for a web page are sent down to interactive television device 14 once and then, only the advanced movie files requiring an update are sent.

FIG. 5 is a flowchart of an exemplary method 64 for providing content to an interactive television device. In step 66, an identifier, for example a URL, is received preferably by information server 40. The identifier identifies the address or location of the content or web page requested by the user of interactive television device 14. If available, the requested content is preferably provided to interactive television device 14 from advanced movie cache 42. As such, in step 68, a determination is made as to whether the identifier is stored in advanced movie cache 42. If the identifier is not stored in advanced movie cache 42, then the process starting at step 74 is executed. If the identifier is stored in advanced movie cache 42, then in step 69, a determination is made as to whether the associated content in advanced movie cache 42 is current. In an exemplary embodiment, this determination is made by information server 40 querying the web site associated with the identifier. If it is determined that the associated content stored in advanced movie cache 42 is not current, then the process starting at step 74 is executed. Otherwise, in step 70, the associated content in the desired advanced movie format is retrieved from advanced movie cache 42. In step 72, the content is transmitted in advanced movie format to interactive television device 14 via head-end 28 and network 26.

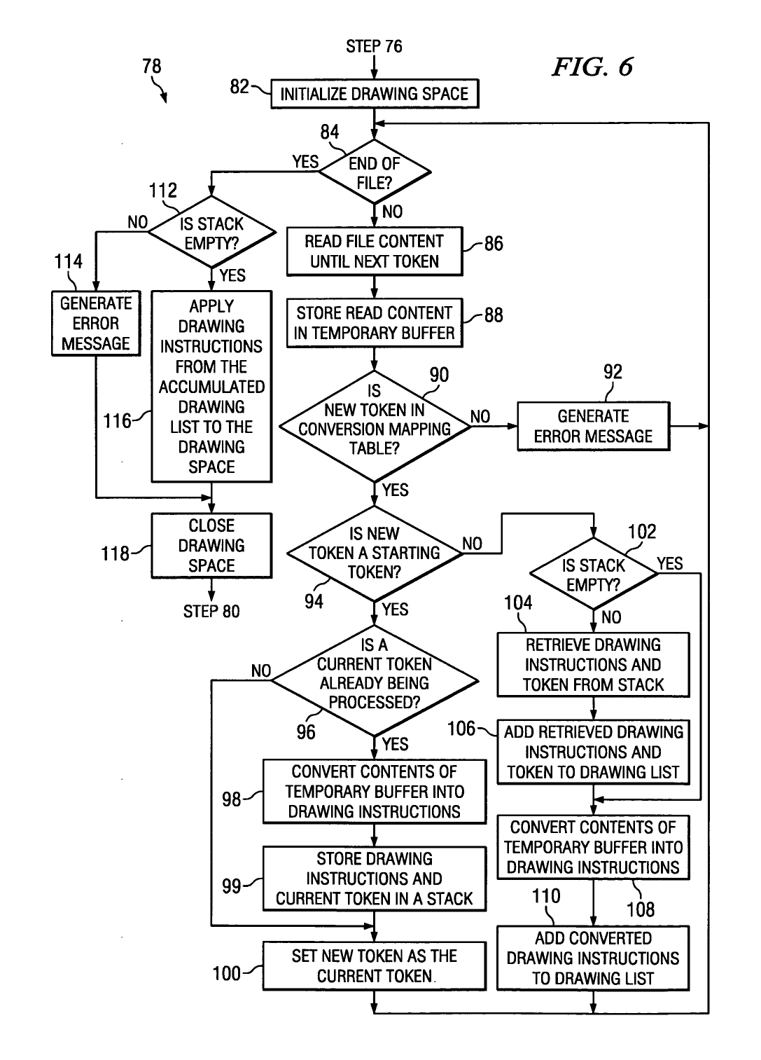

In step 74, the content pointed to by the identifier is retrieved from the corresponding web site via Internet 50. The content retrieved is one or more web pages preferably in HTML format. In step 78, the retrieved content is converted from its current format into an advanced movie format. An exemplary embodiment method for converting the content from its current format into an advanced movie format is discussed herein in greater detail with reference to FIG. 6. In step 80, the content in advanced movie format is stored in advanced movie cache 42. In step 72, the content in advanced movie format is transmitted to interactive television device 14 via head-end 28 and network 26 for display on display device 12.

FIG. 6 is a flowchart of an exemplary method 78 for converting a web page from its current format to an advanced movie format. In step 82, a drawing space for the advanced movie format is initialized. Preferably, the drawing space is simply a white page. The process of reading the contents of the web page is then started. The web page is preferably in HTML format and comprises a file. In step 84, a determination is made as to whether the end of the file has been reached. If the end of the file has not been reached, then in step 86, the content of the file is read until the next token is reached. A token may be a starting token or a terminating token. In an exemplary embodiment, a starting token has a corresponding terminating token and a terminating token has a corresponding starting token. A token is a delimiter that defines or specifies how content in between the starting token and the terminating token is to be displayed. For example, the tokens “<B>” and “</B>” may be used to specify that all text between the two tokens be displayed in bold.

In step 88, the content read from the file is stored in a temporary buffer. In an exemplary embodiment, a mapping table is used to specify a mapping for a token from its current format to a desired advanced movie format. In step 90, a determination is made as to whether the new token is in the mapping table. If the new token is not in the mapping table, then in step 92, an error message is generated and the process starting at step 84 to determine whether the end of the file has been reached is executed.

If in step 90, it is determined that the new token is in the mapping table, then in step 94 a determination is made as to whether the new token is a starting token. If the new token is a starting token, then in step 96 a determination is made as to whether a current token other than the new token is already being processed. If a token other than the new token is already being processed, then in step 98, the contents of the temporary buffer are converted into drawing instructions for the advanced movie format. In step 99, the drawing instructions and the current token are stored in a stack and the process starting at step 100 is executed.

If in step 96, it is determined that a token other than the new token is not already being processed, then the process starting at step 100 is executed. In step 100, the new token is set as the current token. The process starting at step 84 to determine whether the end of the file has been reached may then be executed.

If in step 94, it is determined that the new token is not a starting token, then it is assumed that the new token is a terminating token. In step 102, a determination is made as to whether the stack is empty. If the stack is empty, then the process starting at step 108 may be executed. If the stack is not empty, then in step 104, drawing instructions and a token are retrieved from the stack. In step 106, the retrieved drawing instructions and token are added to a drawing list. The process starting at step 108 may then be executed.

In step 108, the contents of the temporary buffer are converted into drawing instructions for the advanced movie format. In step 110, the converted drawing instructions are added to the drawing list. The process starting at step 84 to determine whether the end of the file has been reached may then be executed.

If in step 84, it is determined that the end of file has been reached, then in step 112, a determination is made as to whether the stack is empty. If the stack is not empty, then in step 114, an error message is generated and the process starting at step 118 may be executed. If the stack is empty, then in step 116, the drawing instructions from the accumulated drawing list are applied to the drawing space to provide at least part of the web page in the advanced movie format. The process starting at step 118 may then be executed. In step 118, the drawing space is closed. If desired, the drawing space may be scaled to correspond to the size of display device 12. The process starting at step 80 may then be executed.

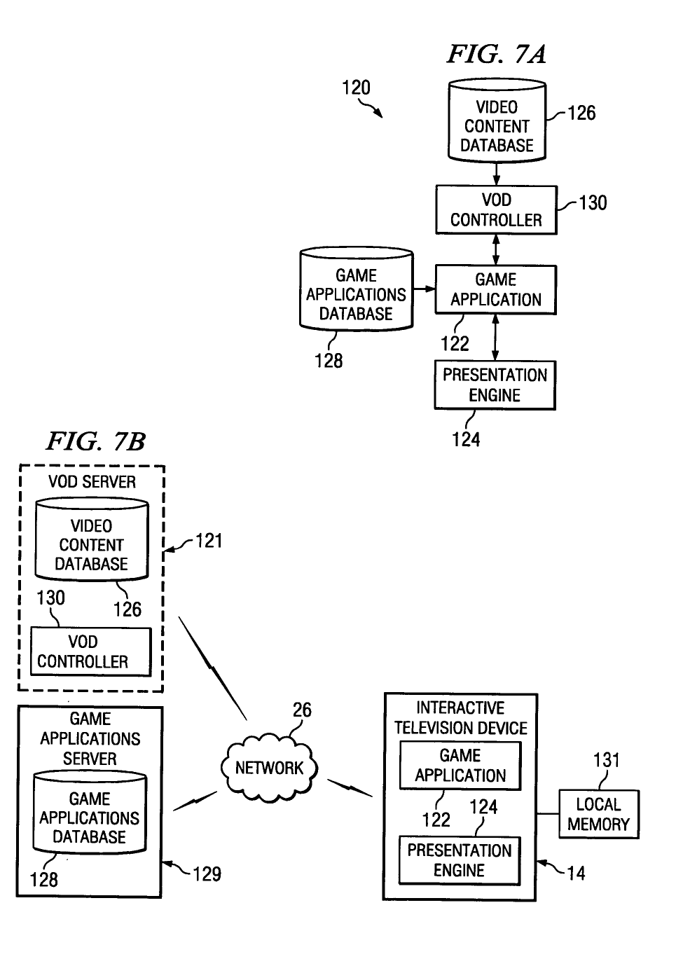

FIG. 7A is a logical diagram of a system 120 for gaming and FIG. 7B is a high-level diagram of system 120. In the context of an on-demand video source, like a VOD server 121, a client/server configuration is utilized. VOD server 121 may be located at head-end 28 (FIG. 2). Presentation engine 124 processes game application 122. The video content is delivered on-demand or from one or more live broadcast channels to the viewers. In a VOD solution, several servers are desirable to accommodate the plurality of viewers within an operator's network. When a viewer is looking at a movie (a video) from an on-demand source, he/she has the same level of control that he/she would have if the movie was playing from a video cassette recorder (VCR). For example, the movie may be paused, rewound, etc.

Streaming the content is, in the illustrated embodiment, done at the server level using the video-on-demand infrastructure or from live broadcast channel(s). If desired, the video content may be stored in local memory 131. Local memory 131 may be part of interactive television device 14 or it may be separate from interactive television device 14. When local memory is separate from interactive television device 14, it may be a floppy disc, an optical disc, a disk drive, and/or the like. Thus, for example, if desired a DVD player may be used to play the video content. On interactive television device 14, an application, such as game application 122, which is preferably in an advanced movie format, provides the interactive part. One application of this idea is to let viewers play a game, using interactive television device 14 and remote control 16, using the video content stream as the game context. An example of such a game is a “shooting game”. Other examples are games like adventure quests, car racing, etc.

One advantage of using the video content stream as the context for the game instead of developing the entire game application on interactive television device 14 is that the graphics for the game may be richer than what current devices are capable of providing. Indeed a video content may be quite pleasing for the eyes but due to the limitations of interactive television device 14, like the graphics system, the limited memory, the limited processing power, etc., it is not possible to create the equivalent effect in a game application using interactive television device 14.

In order to allow the viewer to control the video content stream for the game, it is desirable to deliver the video content from a video content database 126 as well as the game application, with information on interactive elements, from a game applications database 128. This information can take several forms. For example, for a shooting game, the player is shooting at objects in the video content using remote control 16. Thus, it is desirable that game application 122 knows what “hot spots” or “interactive elements” are in the video content. Hot spots are areas where a user input, for example, a hit, will be recorded. The interactive information defines the shape or surface of the hot spots on the screen and the action to take if the player successfully hits them within a specified time.

This information can be represented using different formats, e.g. a text file. Use of an advanced movie format as the mechanism to define the hot spots and the associated actions is preferred. The advanced movie format is a presentation format capable of supporting, but not limited to, one or more of the following: text, graphic drawing, images, animation, sounds and program code. It is desirable that the format work in multiple resolutions. An example of such a format is the MACROMEDIA FLASH format. The advanced movie is used to create interactive content. The movie can have different elements in it, like 2D graphics, audio, etc. The graphics elements may be animated. Some elements can act as triggers for events or be purely cosmetic. For example, if a user clicks on selectable elements, an event occurs and the action corresponding to that event may be executed. It is possible to start the animation of an element at a specific time. Similarly, an element may only exist for a specified period of time.

Thus, using the advanced movie file as a support for the interactive information, it is possible to support various features and/or activities related to the hot spots. A hot spot comprises a selectable graphical shape with an action associated with it. The hot spot may exist for a period of time and its shape may change during that period. If desired, a hot spot may be transparent or have a border.

Video content from video content database 126 and the corresponding advanced movie from advanced movie database 128 are synchronized together and displayed on display device 12. Presentation engine 124 processes game application 122 so that the content stays synchronized. The hot spots are overlaid on top of the video content. In an exemplary embodiment, it may be desirable to display the shapes (or the outlines) of the hot spots. If desired, the shapes may be defined in a separate layer.

When a viewer selects a hot spot, the action associated with that spot is preferably executed. Depending on the logic of the game the action may do one or more things. For instance, if the viewer hits an enemy, points may be earned. If it hits a friend, points may be deducted. Because of the programmable capabilities in the advanced movie format, it is possible to make complex games. However, custom code written in another language, like C++, may also be used in conjunction with an advanced movie file and executed when requested by the game application.

Another advantage of using an advanced movie format for interactive content is that it may be used for the packaging of the entire content. Instead of creating a separate application that drives the manner in which out of game content, such as menus, help, credits, screen settings, etc., is presented to the viewer, the content itself may be built using the advanced movie format. For instance, a menu system giving access to various elements of the content, like those menus found on DVD discs, can easily be built using the advanced movie format.

There are at least two types of authoring. The first one is to create the hot spots. Using the video content, the hot spots may be specified and the associated actions defined. Preferably, every frame of the video content with interactive elements in it has to be processed. The contours of those elements are also defined. Various tools are available to extract contours from video content. The extracted contours may then be loaded in the authoring tool for the advanced format or created straight from it. These contours have to be positioned in time, for example to account for changes in the contours and positions of the interactive elements from one frame to another. An element may exist for a certain period of time.

The second type of authoring is performed on the video content. One objective of this authoring is to add synchronization elements to the video. This may be achieved in different ways. For example, the information for synchronization may simply be the time code of the video signal or may be embedded in the vertical blanking interval (VBI) of the video signal. If desired, the information may be packaged in the data part of a MPEG2 stream.

In a preferred embodiment, the beginning of the video streaming is synchronized with an internal counter in the game application. Typically a single trigger in the VBI or the time code at the beginning of the video, would be enough. If desired, more triggers may be introduced such that the game application has more ways to check that it is in sync with the video content.

Game application 122 running in interactive television device 14 handles one or more aspects of the game, the game play and the out of game functions. Presentation engine 124 processes the advanced movie file comprising the game application and ensures that the video and the game application stay synchronized.

Game application 122 includes a game engine, the game logic and graphics layer for the game. During the execution of the game, different events will occur. The logic handles those events. The logic also covers what is happening when a viewer hits a target. Each target has its own action, i.e. a piece of logic. When a hit is registered, the appropriate action is called. The structure of the movie may also require some logic. For instance, a game will normally offer a menu to the viewer to determine what they want to do, e.g. play the game, get instructions about the game, control the video steaming, etc.

The graphic layer corresponds to the user interface elements for the game application. For example, a shooting game may have a targeting mechanism. Similarly, there will be some score kept for the current game. The layout and the look of these elements are defined in the graphic layer of the game application.

Game application 122 uses the advanced movie format for the structure of the game (logic, graphic layout, etc.). When the viewer decides to play the game, the game application and the video content are desired. The game application would typically be loaded in device memory 20 (FIG. 1). Because of its size, the video content will be received from a live broadcast channel or on-demand from VOD server 121 at head-end 28 via network 26 as a regular broadcast stream. If desired, the video content may be accessed from a local source, like a disc drive. When coming from an on-demand source, game application 122 communicates with a VOD controller 130. Game application 122 directs VOD controller 130 regarding the action to be taken with the video content.

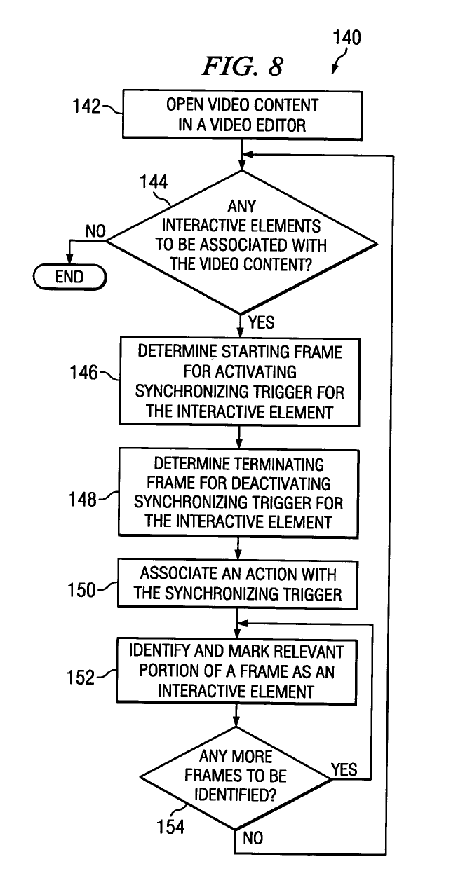

FIG. 8 is a flowchart of an exemplary method 140 for authoring video content to associate synchronizing trigger information for gaming. In step 142, the video content to which interactive elements are to be synchronized is opened, for example using a video authoring software, such as Avid Media Composer. The video content may be in the form of a movie. In step 144, a determination is made as to whether any interactive elements are to be associated with the video content. The game application comprising of interactive information, such as synchronization triggers, contours and spatial location of the interactive elements, is associated with the video content using advanced movie format authoring tools. The game application may be stored in the game applications database 128 (FIGS. 7A and 7B). In an exemplary embodiment, the game application is separate from the video content. If interactive elements are to be associated with the video content, then in step 146, a starting frame of the video content where the interactive element is to be created and the corresponding location in the game application where a synchronizing trigger associated with the interactive element will be activated is determined and marked. In an alternative embodiment, the synchronizing trigger may be provided to the game application from the video content itself. In such an embodiment, the synchronizing trigger points to a position in the game application. In step 148, a terminating frame of the video content for terminating the interactive element and the corresponding location in the game application where the synchronizing trigger associated with the interactive element will be deactivated is determined and marked. In an alternative embodiment, the trigger information may be marked on a data track of the video content itself.

In step 150, the action to be taken when the synchronizing trigger is selected by the user is determined and associated with the synchronizing trigger on the game application. In step 152, the relevant portion of the frame of the video content is identified and marked as an interactive element. In an exemplary embodiment, information about the interactive element, such as the contours, the spatial location, the time period for which the interactive element is to be active, the action associated with the interactive element, etc. are stored in the game application. In step 154, a determination is made as to whether the interactive element is to be marked on any more frames of the video content. If the interactive element is to be marked on additional frames of the video content, then the process starting at step 152 to identify and mark the relevant portion of the frame may be executed. Otherwise, the process starting at step 144 to determine whether any more interactive elements are to be created for the video content is executed. If no more interactive elements are to be created for the video content, then the process ends.

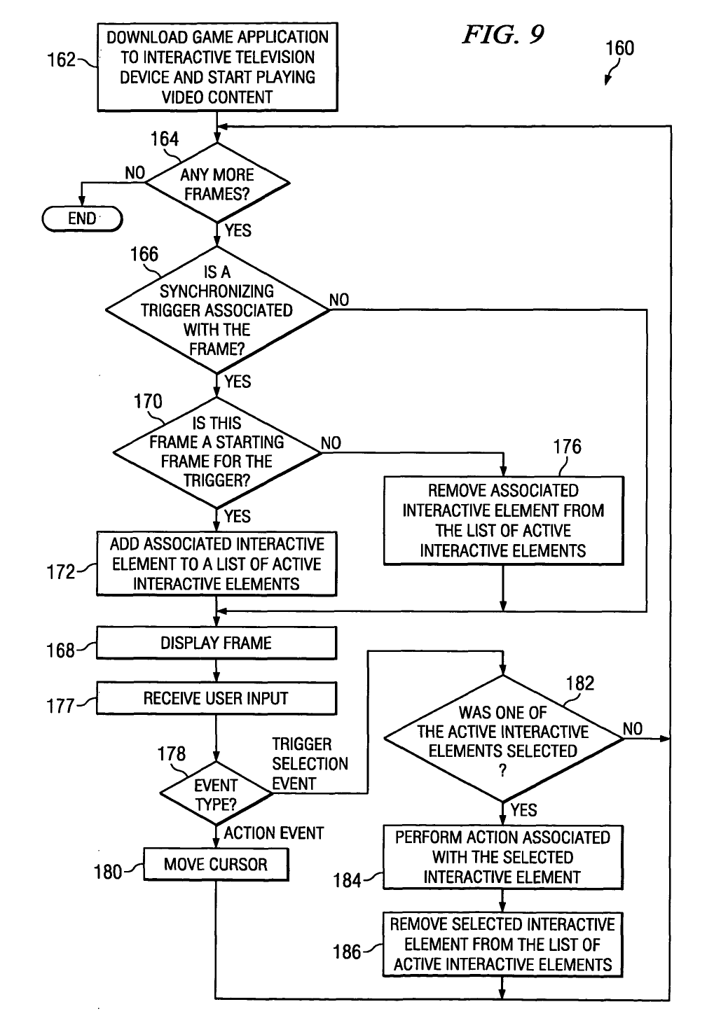

FIG. 9 is a flowchart of an exemplary method 160 for synchronizing video content and the game application, with reference to an interactive television device. The video content of the game is preferably stored in video content database 126 at head-end 28 and is preferably in a digital video format. In step 162, the game application is downloaded to interactive television device 14 from game applications server 129 located in head-end 28 via network 26. The streaming of the video content for the game context may be initiated by the game application. If desired, the game application may be downloaded via any type of packet network. The entire game application may be stored in interactive television device 14. In an alternative embodiment, if the size of the game application is large, then portions of it may be accessed or downloaded from game applications server 129 as and when desired. In an exemplary embodiment, the video content is accessed and played using either live broadcast channel or a VOD infrastructure, through VOD controller 130 and head-end 28. The video content may be received via RF signal 24 (FIG. 1). If desired, in an alternative embodiment, the video content may be downloaded from VOD server 121 and stored in interactive television device 14. If desired, the video content may be accessed from a local source, for example a DVD player. In another alternative embodiment, the video content may be accessed and played as a video stream using any type of packet network.

In step 164, a determination is made as to whether there are any more frames in the video content. If there are additional frames in the video content, then in step 166, a determination is made as to whether a synchronizing trigger is associated with the frame. The game application may be examined to determine if the frame has a synchronizing trigger associated with it. In an exemplary embodiment, the game application and the video content are played simultaneously. As such, presentation engine 124 knows which frame of the video content is being presented and may examine game application 122 to determine if a synchronizing trigger is associated with that frame. In an alternative embodiment, the synchronizing trigger may be provided on a data stream of the video content. The synchronizing trigger on the data stream of the video content identifies the portion of the game application where the associated interactive element is stored.

If the frame does not have a synchronizing trigger associated with it, then the process starting at step 168 may be executed. If the frame has a synchronizing trigger associated with it, then in step 170, a determination is made as to whether the current frame is a starting frame for the synchronizing trigger. In other words, a determination is made as to whether this is the first frame during which the synchronizing trigger is to be activated. If the current frame is a starting frame for the synchronizing trigger, then in step 172, a hot spot or interactive element associated with the frame and the synchronizing trigger is added to a list of active interactive elements and the process starting at step 168 may be executed.

Each synchronizing trigger is active for a predefined period of time. If in step 170, it is determined that the current frame is not the starting frame for the synchronizing trigger, then that indicates that the current frame is a terminating frame for the synchronizing trigger and in step 176, the interactive element associated with the frame and the synchronizing trigger is removed from the list of active interactive elements and the process starting at step 168 may be executed.

In step 168, the current frame is displayed on display device 12. Interactive elements, if any, associated with the frame may also be displayed with the current frame. In step 177, input from the user is received. In step 178, a determination is made as to what type of user input or event has been received. If the event type is an action event, for example selection of a navigation key, such as an arrow key, and/or the like, then in step 180, the cursor is moved to an appropriate location on display device 12 and the process starting at step 164 may be executed.

If in step 178, it is determined that the event type is a trigger selection event, for example if the user selects an action key, then in step 182, a determination is made as to whether one of the active interactive elements was selected. In an exemplary embodiment, this determination is made by determining whether the cursor is in a predetermined relationship with one of the active interactive elements. In an exemplary embodiment, the determination of the predetermined relationship may involve a determination of whether the cursor is inside one of the active interactive elements. If one of the active interactive elements was not selected, then the process starting at step 164 may be executed. If an active interactive element was selected, then in step 184, the action associated with the selected interactive element is executed. In an exemplary embodiment, the action associated with the selected interactive element is executed. Once the action associated with the selected interactive element is executed, in step 186, the selected interactive element may be removed from the list of active interactive elements and the process starting at step 164 to determine if there are any more frames in the video content may be executed. If in step 164, it is determined that there are no more frames in the video content, then the process ends.

Embodiments of the present invention may be implemented in software, hardware, or a combination of both software and hardware. The software and/or hardware may reside on information server 40, VOD server 121, game applications server 129 or interactive television device 14. If desired, part of the software and/or hardware may reside on information server 40, part of the software and/or hardware may reside on VOD server 121, part of the software and/or hardware may reside on game applications server 129, and part of the software and/or hardware may reside on interactive television device 14.

If desired, the different steps discussed herein may be performed in any order and/or concurrently with each other. Furthermore, if desired, one or more of the above described steps may be optional or may be combined without departing from the scope of the present invention.

While the invention has been particularly shown and described by the foregoing detailed description, it will be understood by those skilled in the art that various other changes in form and detail may be made without departing from the spirit and scope of the invention.

What is claimed is:

1. A computer-readable medium for interactive game playing having stored thereon an instruction set to be executed, the instruction set, when executed by a processor, causes the processor to perform the steps of:
receiving at least a portion of a video content for a game environment over a network;
receiving at least a portion of a game application comprising of one or more interactive elements for said game playing; and
synchronizing the received video content with the received game application to present said one or more interactive elements in said game environment.

2. The computer-readable medium of claim 1, further causing the processor to perform the step of storing said at least a portion of said game application in an interactive television device.

3. The computer-readable medium of claim 1, wherein the one or more interactive elements comprise at least one action for execution in response to any input of a user made in connection with a frame of said received video content.

4. The computer-readable medium of claim 1, wherein said at least a portion of said video content is received on-demand from a remote server in response to a request for said video content by a user.

5. The computer-readable medium of claim 1, wherein said at least a portion of said video content is received live from one or more broadcast channels in response to a request for said video content by a user.

6. The computer-readable medium of claim 1, further causing the processor to perform the step of determining whether a synchronizing trigger is associated with a current frame of said video content.

7. The computer-readable medium of claim 6, further causing the processor to perform the step of examining said at least a portion of said game application to determine whether a synchronizing trigger is associated with said current frame.

8. The computer-readable medium of claim 6, further causing the processor to perform the step of determining whether said current frame is a starting frame for said synchronizing trigger.

9. The computer-readable medium of claim 6, further causing the processor to perform the step of activating an interactive element of said one or more interactive elements in response to said current frame being a starting frame for said synchronizing trigger, wherein said activated interactive element is associated with said synchronizing trigger.

10. The computer-readable medium of claim 9, further causing the processor to perform the step of displaying a representation of said activated interactive element and said current frame on a display device.

11. The computer-readable medium of claim 6, further causing the processor to perform the step of determining whether said current frame is a terminating frame for said synchronizing trigger.

12. The computer-readable medium of claim 6, further causing the processor to perform the step of deactivating an interactive element of said one or more interactive elements in response to said current frame being a terminating frame for said synchronizing trigger, wherein said deactivated interactive element is associated with said synchronizing trigger.

13. The computer-readable medium of claim 12, further causing the processor to perform the step of displaying said current frame on a display device without a representation of said interactive element.

14. The computer-readable medium of claim 7, further causing the processor to perform the step of displaying said current frame on a display device.

15. The computer-readable medium of claim 14, further causing the processor to perform the step of receiving a selection from a user.

16. The computer-readable medium of claim 15, further causing the processor to perform the step of determining whether said selection is associated with an interactive element of said one or more interactive elements.

17. The computer-readable medium of claim 15, further causing the processor to perform the step of determining whether a pointer associated with said game application is in a predetermined relationship with respect to an interactive element of said one or more interactive elements.

18. The computer-readable medium of claim 16, further causing the processor to perform the step of executing a predetermined action associated with said interactive element in response to said selection being associated with said interactive element.

19. The computer-readable medium of claim 1, wherein said at least a portion of said game application is received over an interactive television network.

20. The computer-readable medium of claim 1, wherein said at least a portion of said game application is received over an interactive television network using an RF signal.

21. The computer-readable medium of claim 1, wherein said at least a portion of said game application is received over a video-on-demand system.

22. The computer-readable medium of claim 1, wherein said at least a portion of said game application is received over a satellite system.

23. The computer-readable medium of claim 1, wherein said at least a portion of said game application is received over a cable system.

24. The computer-readable medium of claim 1, wherein said at least a portion of said game. application is received over a broadcast system.

25. The computer-readable medium of claim 1, wherein said at least a portion of said game application is received over a data network.

26. An apparatus for interactive game playing, comprising:
a device, comprising:
a processor; and
a memory having stored thereon an instruction set to be executed, the instruction set, when executed by said processor, causes the processor to perform the steps of:
receiving at least a portion of a video content for a game environment over a network;
receiving at least a portion of a game application comprising of one or more interactive elements for said game playing; and
synchronizing the received video content with the received game application to present said one or more interactive elements in said game environment.

27. The apparatus of claim 26, further causing the processor to perform the step of storing said at least a portion of said game application in an interactive television device.

28. The apparatus of claim 26, wherein the one or more interactive elements comprise at least one action for execution in response to any input of a user made in connection with a frame of said received video content.

29. The apparatus of claim 26, wherein said at least a portion of said video content is received on-demand from a remote server in response to a request for said video content by a user.

30. The apparatus of claim 26, wherein said at least a portion of said video content is received live from a broadcast channel in response to a request for said video content by a user.

31. The apparatus of claim 26, further causing the processor to perform the step of determining whether a synchronizing trigger is associated with a current frame of said video content.

32. The apparatus of claim 31, further causing the processor to perform the step of examining said at least a portion of said game application to determine whether a synchronizing trigger is associated with said current frame.

33. The apparatus of claim 31, further causing the processor to perform the step of determining whether said current frame is a starting frame for said synchronizing trigger.

34. The apparatus of claim 31, further causing the processor to perform the step of activating an interactive element of said one or more interactive elements in response to said current frame being a starting frame for said synchronizing trigger, wherein said activated interactive element is associated with said synchronizing trigger.

35. The apparatus of claim 34, further causing the processor to perform the step of displaying a representation of said activated interactive element and said current frame on a display device.

36. The apparatus of claim 31, further causing the processor to perform the step of determining whether said current frame is a terminating frame for said synchronizing trigger.

37. The apparatus of claim 31, further causing the processor to perform the step of deactivating an interactive element of said one or more interactive elements in response to said current frame being a terminating frame for said synchronizing trigger, wherein said deactivated interactive element is associated with said synchronizing trigger.

38. The apparatus of claim 37, further causing the processor to perform the step of displaying said current frame on a display device without a representation of said interactive element.

39. The apparatus of claim 32, further causing the processor to perform the step of displaying said current frame on a display device.

40. The apparatus of claim 39, further causing the processor to perform the step of receiving a selection from a user.

41. The apparatus of claim 40, further causing the processor to perform the step of determining whether said selection is associated with an interactive element of said one or more interactive elements.

42. The apparatus of claim 40, further causing the processor to perform the step of determining whether a pointer associated with said game application is in a predetermined relationship with respect to an interactive element of said one or more interactive elements.

43. The apparatus of claim 41, further causing the processor to perform the step of executing a predetermined action associated with said interactive element in response to said selection being associated with said interactive element.

44. The apparatus of claim 26, wherein said at least a portion of said game application is received over an interactive television network.

45. The apparatus of claim 26, wherein said at least a portion of said game application is received over an interactive television network using an RF signal.

46. The apparatus of claim 26, wherein said at least a portion of said game application is received over a video-on-demand system.

47. The apparatus of claim 26, wherein said at least a portion of said game application is received over a satellite system.

48. The apparatus of claim 26, wherein said at least a portion of said game application is received over a cable system.

49. The apparatus of claim 26, wherein said at least a portion of said game application is received over a broadcast system.

50. The apparatus of claim 26, wherein said at least a portion of said game application is received over a data network.

51. A method for interactive game playing, comprising:
receiving at least a portion of a video content for a game environment over a network;
receiving at least a portion of a game application comprising of one or more interactive elements for said game playing; and
synchronizing the received video content with the received game application to present said one or more interactive elements in said game environment.

52. The method of claim 51, further comprising storing said at least a portion of said game application in an interactive television device.

53. The method of claim 51, wherein the one or more interactive elements comprise at least one action for execution in response to any input of a user made in connection with a frame of said received video content.

54. The method of claim 51, wherein said at least a portion of said video content is received on-demand from a remote server in response to a request for said video content by a user.

55. The method of claim 51, wherein said at least a portion of said video content is received live from a broadcast channel in response to a request for said video content by a user.

56. The method of claim 51, further comprising determining whether a synchronizing trigger is associated with a current frame of said video content.

57. The method of claim 56, further comprising examining said at least a portion of said game application to determine whether a synchronizing trigger is associated with said current frame.

58. The method of claim 56, further comprising determining whether said current frame is a starting frame for said synchronizing trigger.

59. The method of claim 56, further comprising activating an interactive element of said one or more interactive elements in response to said current frame being a starting frame for said synchronizing trigger, wherein said activated interactive element is associated with said synchronizing trigger.

60. The method of claim 59, further comprising displaying a representation of said activated interactive element and said current frame on a display device.

61. The method of claim 56, further comprising determining whether said current frame is a terminating frame for said synchronizing trigger.

62. The method of claim 56, further comprising deactivating an interactive element of said one or more interactive elements in response to said current frame being a terminating frame for said synchronizing trigger, wherein said deactivated interactive element is associated with said synchronizing trigger.

63. The method of claim 62, further comprising displaying said current frame on a display device without a representation of said interactive element.

64. The method of claim 57, further comprising displaying said current frame on a display device.

65. The method of claim 64, further comprising receiving a selection from a user.

66. The method of claim 65, further comprising determining whether said selection is associated with an interactive element of said one or more interactive elements.

67. The method of claim 65, further comprising determining whether a pointer associated with said game application is in a predetermined relationship with respect to an interactive element of said one or more interactive elements.

68. The method of claim 66, further comprising executing a predetermined action associated with said interactive element in response to said selection being associated with said interactive element.

69. The method of claim 51, wherein said at least a portion of said game application is received over an interactive television network.

70. The method of claim 51, wherein said at least a portion of said game application is received over an interactive television network using an RF signal.

71. The method of claim 51, wherein said at least a portion of said game application is received over a video-on-demand system.

72. The method of claim 51, wherein said at least a portion of said game application is received over a satellite system.

73. The method of claim 51, wherein said at least a portion of said game application is received over a cable system.

74. The method of claim 51, wherein said at least a portion of said game application is received over a broadcast system.

75. The method of claim 51, wherein said at least a portion of said game application is received over a data network.
